(19) United States
(12) Patent Application Publication
(10) Pub. No.: US 2013/0159118 A1
(43) Pub. Date: Jun. 20, 2013

(54) System and Method for Mobile Retail Transaction Processing

(71) Applicants: Bradford D. Ress, Boca Raton, FL (US); Victor Alan Bates, New Port Richey, FL (US)

(72) Inventors: Bradford D. Ress, Boca Raton, FL (US); Victor Alan Bates, New Port Richey, FL (US)

(21) Appl. No.: 13/693,215

(22) Filed: Dec. 4, 2012

Related U.S. Application Data
(63) Continuation-in-part of application No. 13/213,034, filed on Aug. 18, 2011.

(51) Int. Cl. G06Q 20/32; G06K 5/00

(52) U.S. Cl. CPC G06Q 20/3226; G06K 5/00
USPC 705/18; 705/16; 235/380

(57) ABSTRACT

A system and method for processing retail transactions using a mobile device wherein a merchant has a mobile data processing device (such as a smart phone) into which he enters information about the transaction, then prepares a message to the processor of the transaction using a magnetic stripe reader coupled to his data processing device to provide a token which is authenticated by the processor of the transaction. The system may prepare a message regarding the transaction to a customer so that the customer may participate in the transaction, e.g., by entering an account number or PIN at his terminal, content which is used by the processor without being available to the merchant.

### CROSS-REFERENCE TO RELATED PATENT

The present invention claims the benefit of our earlier co-pending patent application, Ser. No. 13/213,034 filed Aug. 18, 2011 and entitled “Payment Processing System and Method” (sometimes referred to as the “Balance Billing Patent”). This is a continuation-in-part of the Balance Billing Patent.

### BACKGROUND OF THE INVENTION

1. Field of the Invention

The present invention relates to an improved system and method for the processing of retail transactions in a mobile environment. Such a mobile environment envisions that the merchant may (but is not required to) process transactions away from a fixed retail location and would include merchants at flea markets, street vendors and those who sell merchandise and/or provide services at customer locations.

2. Background Art

Various methods and systems exist for processing of retail transactions. For example, stores often use a point of sale terminal (or collection of terminals) attached to a communications system and redundant processor system (e.g., like the IBM 4680 retail store system) for linking to a data processing network for processing credit and debit card transactions and for maintaining inventory and sales records. In addition, magnetic stripe readers have been used to advantage in a variety of uses, including in automatic teller machines, retail vending machines and at teller stations in a financial institution for reading a credit card or a debit card, with the reader attached to a bank teller processing system using the IBM “B loop” protocol.

Many of these retail transactions involve customers who wish to use credit cards, debit cards or other forms of non-cash payment methods (like personal checks, travelers checks or postal giro instruments) where the merchant wishes to know that the payment is good—that the credit card will be honored or the check will be paid by the financial institution upon formal presentment. Since credit cards may be stolen or otherwise invalid (exceeding a customer's credit limit, expired cards or the account closed), the merchant typically wants a quick and easy way to verify that the card is good and the instrument will be honored when presented. This is especially true at mobile locations such as flea markets, street vendors and other temporary sales locations where wired phone and internet service may not be available at the location.

Such sales locations often involved vendors who are not located there permanently and may not have a permanent place of business and can involve mobile devices. As a result, some customers may be reluctant to provide credit card information directly to a mobile merchant for fear that his payment information will be compromised or misused and that it will be difficult to find the merchant again to recover from a loss of sensitive data.

Some of the transaction processing systems have tools which are designed for security of the system but which insert a degree of delay or difficulty for a mobile merchant. For example, one such payment system requires a large password and then requires log-in if the terminal has been idle for more than fifteen minutes. This means that the mobile merchant (or any other merchant who has only sporadic credit card transactions) must log in often and insert some kind of large password, making the transaction lengthy and cumbersome (as well as requiring a password which must be secured but may be difficult to remember, due to its length).

Accordingly, it will be apparent to one skilled in the art that the prior art systems and methods for providing processing of retail transactions have undesirable limitations and disadvantages.

### SUMMARY OF THE INVENTION

The present invention overcomes the disadvantages of the prior art systems for mobile transaction processing. It provides an improved system and method for processing of retail transactions at locations where fixed (or wired, plain old telephone service) telecommunication facilities may not be available. It also provides a system and method for securing data from improper access or misuse.

The present system and method includes one optional arrangement for using a magnetic stripe card (or similar token) to provide a password which is quickly and easily scanned into the payment processing system when required. This one magnetic stripe reader is also useful in reading the credit or debit card of a customer for processing of a credit card or debit card transaction, so that an additional input device is not required.

Another optional feature of the present invention includes an arrangement whereby a retail customer can be sent the details of a transaction to approve and use his credit card (or similar payment system, such as a debit card, PayPal account or check) in payment without providing the details of the credit card (or other payment method) to the merchant, allowing the customer to have greater security over the information relating to his payment. This transaction processing system and method also can send (if desired) the customer a confirmation (such as a receipt) of his retail transaction without requiring a printer at the point of sale.

The present invention provides for several useful, but optional, additional features. For example, the data processing system of the present invention may include a stored inventory of the merchandise and prices so that the merchant (or even the customer) can quickly and easily enter the transaction, compute any taxes or additional charges and present the total for his review and that of his customer. Such a transaction processing system and method can also include sales and inventory records to facilitate analysis of sales information, as well as maintaining inventory control systems to facilitate reordering and loss detection.

Of course, a system where the inventory is loaded into a data processing device allows for the merchant to maintain sales information and inventory records in a convenient way. This allows for ease in reordering (perhaps through an automatic replenishment system or other automated reordering) and for sales tracking—showing where and when what items were sold, and even to whom.

Other objects and advantages of the present invention will be apparent to those of ordinary skill in the art to which the present invention pertains in view of the following detailed description taken in conjunction with the accompanying drawings.

### BRIEF DESCRIPTION OF THE DRAWINGS

FIG. 1 shows a pictorial representation of system components according to a first exemplary environment of the present invention;

FIG. 1a shows a front view of the hardware components of one illustrative system of the present invention;

FIGS. 2a-2q show screen shots from a terminal (smart phone) which uses a stored software program to practice various aspects of the present invention; and

FIG. 3 shows a flow chart for the operations of one method of carrying out the present invention using the terminal (smart phone) previously mentioned using a stored software program for invoicing and payment processing.

### DETAILED DESCRIPTION OF THE PREFERRED EMBODIMENTS

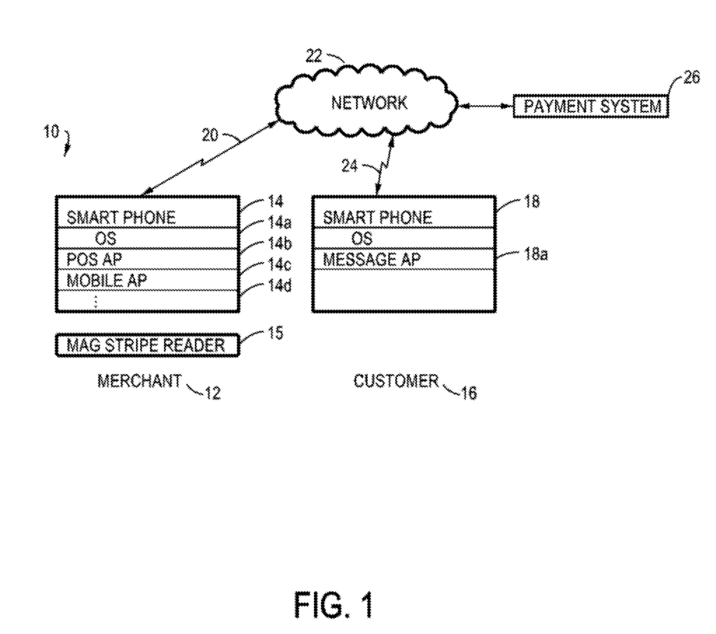

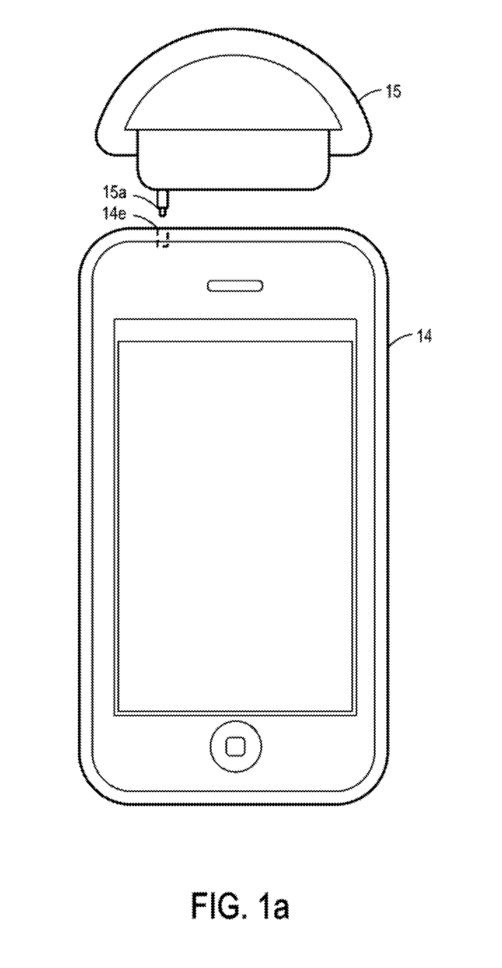

FIG. 1 illustrates typical embodiment 10 of the present invention. A merchant 12 has a smart phone or portable communication device 14 which includes hardware and software for practicing the present invention. A customer 16 has his own terminal 18 (which could be his cell phone or his smart phone or a data terminal) which includes at least a conventional message application 18a (such as a text message or email system), but does not require any special-purpose software (software which is unique to the transaction processing system of the present invention, meaning that the customer 16 would not have to download an application or otherwise have some unique software in order to conduct a transaction or receive a receipt from the transaction processing system of the present invention. The merchant's smart phone 14 includes a conventional operating system 14a, a point-of-sale (POS) software application 14b, a mobile software application 14c and, optionally, other software 14d as desired. The merchant's smart phone 14 has an operational communication link 20 to a communications network 22 such as the Internet or a similar network (such as a virtual private network). Coupled to the smart phone 14 is a magnetic stripe reader 15.

The magnetic stripe reader 15 may be a conventional, generally-available device, usually compact and easily portable, such as the magnetic stripe reader UniMag, Mobile MagStripe Reader from IDTech Products described at http://idtechproducts.com/products/mobile-readers/112.html. This magnetic stripe reader can be connected to the merchant's smart phone 14 in any conventional way, such as plugging an external jack into the 3.5 mm headphone jack (audio input) of the terminal 14, although other communication techniques, including wireless communications between the magnetic stripe reader 15 and the terminal 14, such as Bluetooth, could be used to advantage in some alternatives of the present invention. The magnetic stripe reader 15 as used in the present invention may be powered in a conventional manner, such as from the smart phone, or it may be independently powered by an internal power supply (one or more batteries carried within it) or by its own plug to conventional electrical current from a 110 volt alternating current supply (a system which probably would include a rectifier to provide direct current as well as a transformer to reduce the voltage).

The customer 16 may (or may not) have his own communications device (such as his own smart phone 18) with its operating system (OS) and a message application 18a which comprises an email system and/or a text messaging system as well as other conventional application, as desired. The smart phone 18 of the customer 16 can be coupled to the network 22 through a link 24 so as to receive messages from the network 22 and send messages to others using the data transmission network 22. In the present system, the merchant 12 can send the customer 16 a receipt, if desired, using the same data transmission network 22 and the customer's terminal or smart phone 18, and would not require that the customer 16 have any special software on his terminal or smart phone 18 (the “receipt” could be either in the form of a conventional text message or in the form of a conventional email). In either case, the customer would have a document of his transaction with the necessity of either the merchant 12 or the customer 16 having a printer at the site of the transaction (such as a mobile location or “flea market”). The message from the merchant 12 to the customer 16 could also be in the form of an “invoice” for the customer 16 to prepare and send a payment using his credit or debit card, if desired, as explained later in this document. Of course, either the merchant 12 or the customer 16 could be using a tablet computer or another portable device such as an iPOD or an iPad as their portable terminal and communications device, as desired, or the messages and receipt could be sent to a desktop computer located at a remote location, such as the home of the customer 16, or the email of the customer 16, if the customer does not wish to review such message at the time the transaction is being conducted (which is relatively contemporaneously with the transaction at the location of the merchant, while the customer is with the merchant).

Also connected to the network 22 can be at least one payment system 26 for receiving information about a proposed payment and providing an approval of that transaction. If the transaction is a credit card payment, then the payment system 26 might be a merchant's credit card processing system authorized by the credit card company (e.g., VISA) to check authenticity and balances and provide an acceptance or rejection of any proposed transaction using that payment system. The payment system 26 which is used by a given merchant 12 may also include a check guarantee system or a credit bureau, as desired by the merchant 12. The payment processing system also could be an independent service such as PayPal which provides a payment transmission and guarantee. As will be described later, the payment processing system 26 may be invoked by the customer 16, if desired, rather than the merchant 12 so that the customer's personal information (credit card number, address, expiration date, security code, etc.) may be secured and not disclosed to the merchant 12.

One form of a terminal-based storefront software allows for the rapid creation of a smart-phone based storefront with photo, description pricing and other options such as sales tax, shipping, optional features and services. The user can use a camera (either from his smart phone or other terminal or a stand-alone digital camera which uploads pictures to the terminal) to capture a photo of the article and associate it with the descriptive material. The user can add pricing and descriptive material associated with the picture using the keyboard of the smart phone or terminal or using voice recognition, as desired. Additional features such as color, quantity, size selectors, item category can be added as appropriate to allow for ease in searching for the item later.

The smart phone based transaction processing system often has a “shopping cart” where items selected by a single customer can be aggregated into a single transaction. Such software creates a separate shopping cart for each customer, with relevant identification (such as customer identification and/or contact information). As the customer selects items from the stored invention, those items are moved into the customer's shopping cart from the storefront inventory. The software automatically calculates pricing totals, any shipping, taxes or other fees, and even can suggest auxiliary goods and services which the customer may wish to add to the cart—for example, if the customer buys a printer, the software can prompt the customer about supplies (like toner) and services (an extended warranty) or even software and set up services, if available.

The software involved in the transaction processing system also can recognize when a transaction has been completed and decrement the inventory in the store by the quantity sold and generate any necessary reports (for example, warranty registration).

The software generates a sales invoice summary which may be displayed on the merchant's smart phone 14 for the customer 16 (and/or the merchant 12) to confirm the accuracy of the transaction and for the customer to confirm the transaction (i.e., by paying the amount due).

This transaction processing software (the mobile ap (or application) 14d) resides in the merchant's terminal 14 (or smart phone) in the preferred embodiment, but it could also reside on a central host processing system (if the merchant has a central host processing system, which may support multiple merchant smart phones as point of sale terminals 14 associated with a single “store” or the application could be resident on the network 22 using a form of cloud computing, if desired, and accessed through the operational communications link 20.

The shopping cart information (summary and payment information) can be transmitted from the merchant 12 and his smart phone 14 to the customer 16 and his terminal 18 using SMS, TXT, email or other channels having similar electronic communication capabilities

The merchant 12 (through his terminal 14) may send the customer 16 (through his terminal 18) an invoice with payment links contained within the message (the invoice.) Processing credit card information at the customer's terminal 18 means that the payment card details are not exposed to the merchant's terminal 14 or the shopping cart application.

The customer 16 follows a payment link associated with the transaction to a payment portal (which is preferably PCI-compliant). Once the customer enters his payment information and the processing confirms that the payment is good, notification is sent to both the merchant 12 and the customer 16 via a preferred channel (SMS, TXT, email, etc.) with appropriate technical assurance (e.g., digital signature, token) confirming the successful payment and completing the sale. The payment processing system may also be used for payment voiding operations which may be initiated from the merchant 12. This online mobile transaction processing system expedites the payment method acceptance (payment card, e-wallet, ACH, etc.) which are linked to the point of sale application.

FIG. 1a shows the hardware components of a representative embodiment of the hardware of a merchant 12 using the present invention. The smart phone 14 or similar terminal includes one or more stored programs to carry out the present invention in processing data and communicating with a remote data processing network 22. The magnetic stripe reader 15 is positioned adjacent to the smart phone 14 to be coupled with the smart phone 14 using an external jack 15a extending from the magnetic stripe reader 15 and mating with a recessed connector 14e associated with the smart phone 14.

Although the details of the structure and operation of a magnetic stripe reader 15 are not particularly important to an understanding of the present invention, typically the reader 15 is designed to read a magnetic stripe carried on a credit card or similar identification card, similar to that which is used in a point of sale machine where a credit card or debit card is used to conduct a transaction (or an ATM card is used to initiate a transaction at an automatic teller machine). Standards adopted by the relevant industry define the location and content of the magnetic stripe and the number of lines of information, standards which are also not particularly necessary for the understanding of the present invention. Such magnetic stripes on cards used in the United States often include three horizontal lines or tracks of information, with standards for what information is included in each track and how the magnetic information is coded for reading in a uniform and consistent manner. For example, one track may include the account number twice (the second occurrence being a redundancy in case part of the first instance is not read properly). Another track may include the customer's name. However the information is set up on the magnetic stripe, the reader is positioned and programmed to read selected locations and present the read information in digital form for further processing. In this instance, the account number of approximately 16 digits (or 32, if the second occurrence is considered) may be read from a credit card swiped through the magnetic stripe reader 15 and transmitted to the smart phone 14 for further processing.

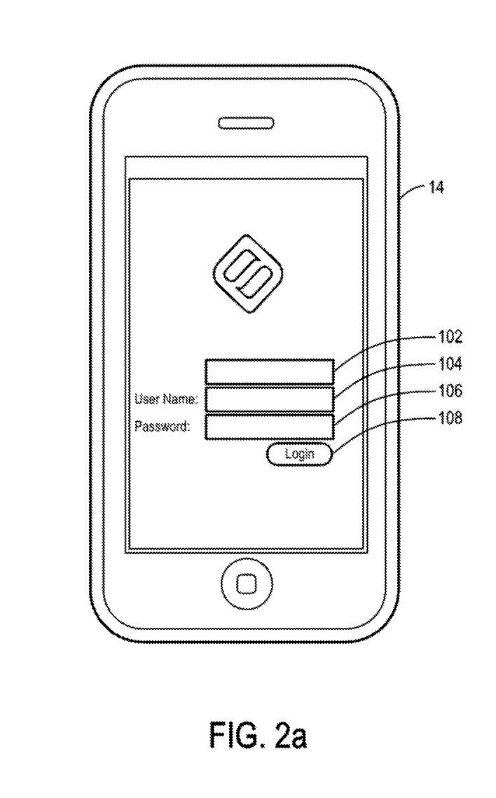

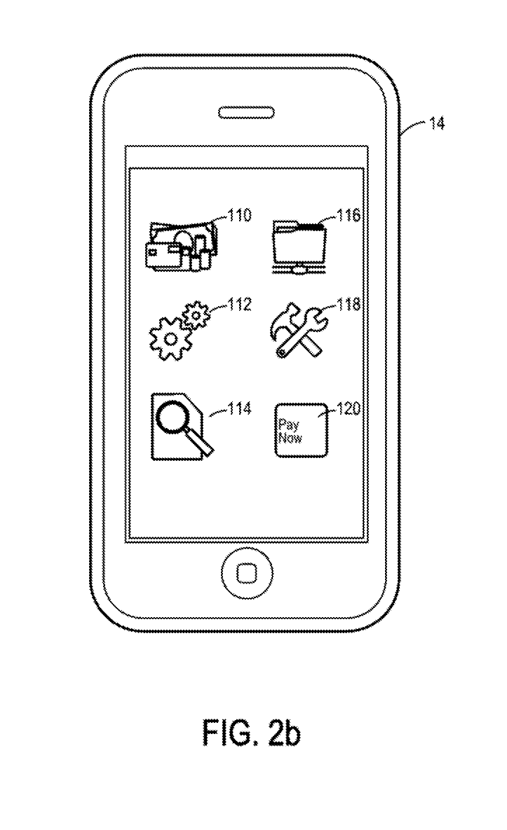

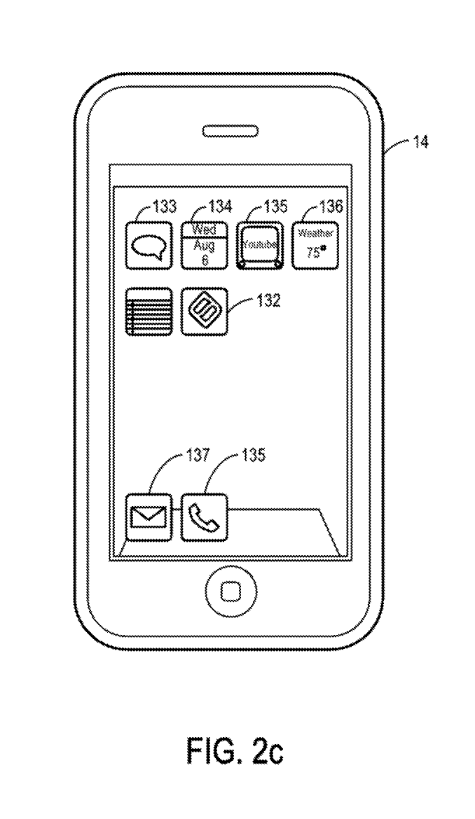

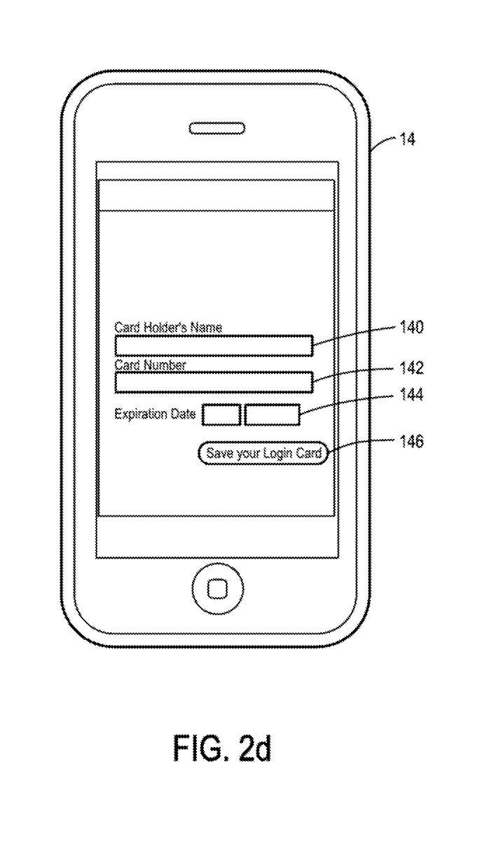

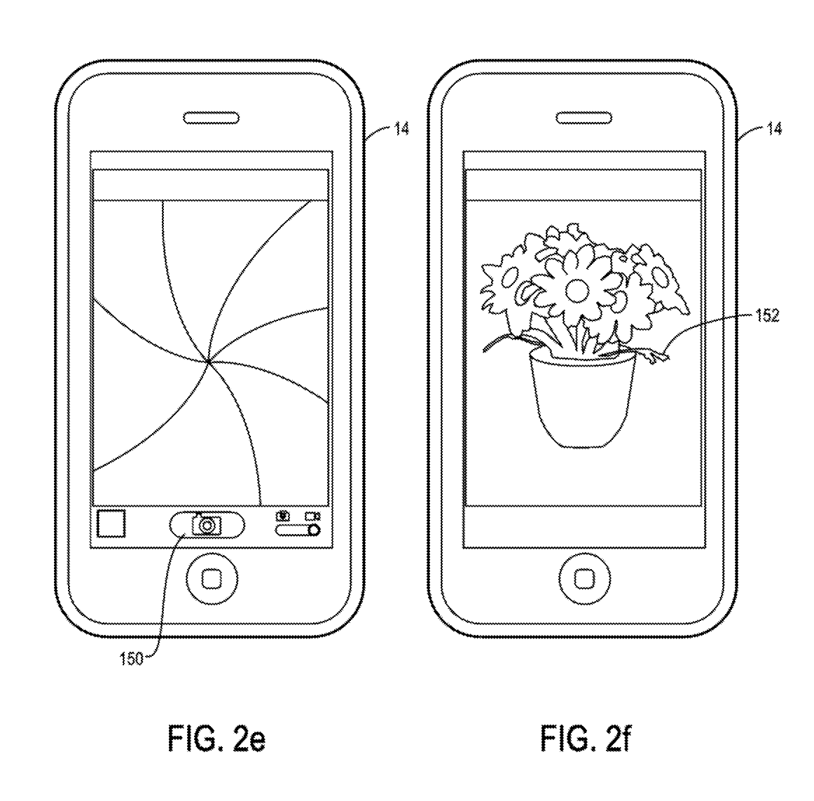

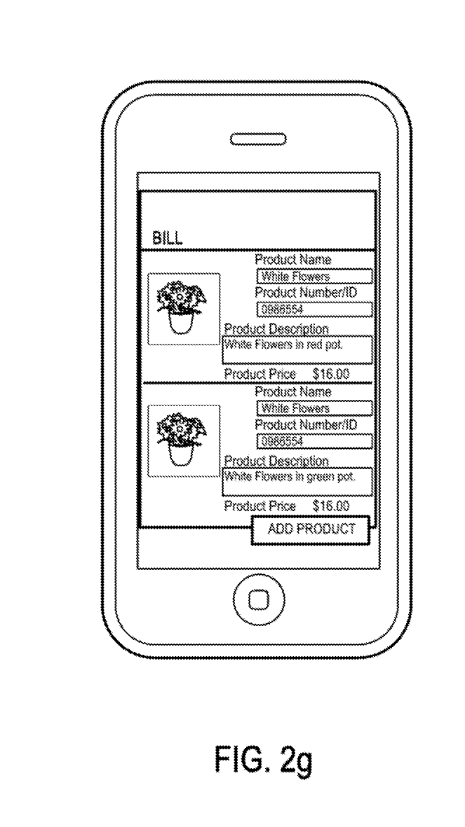

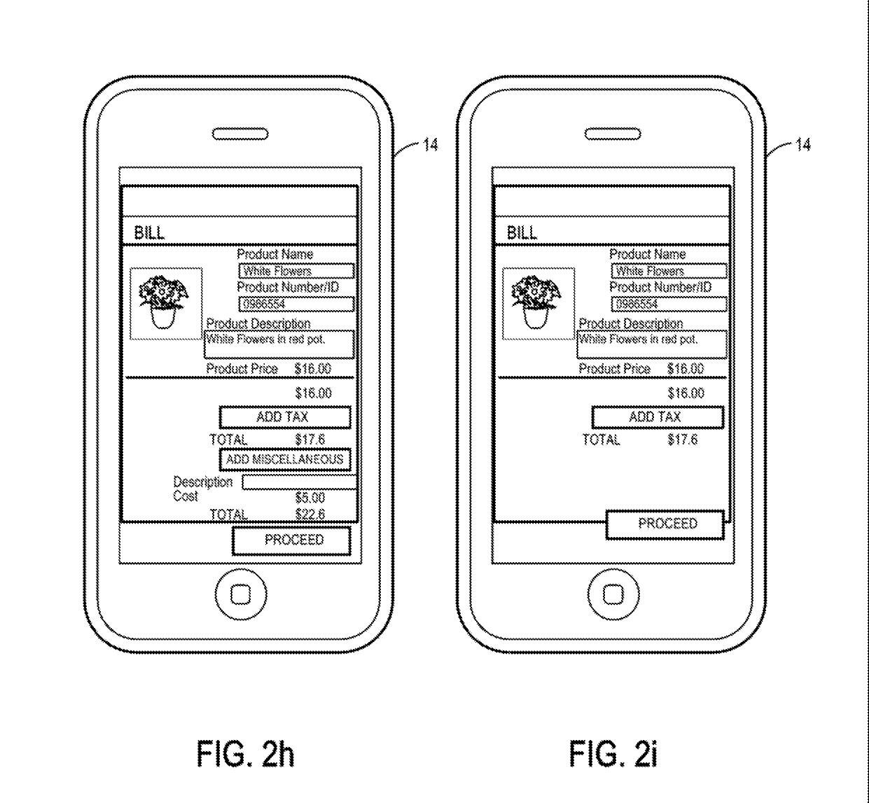

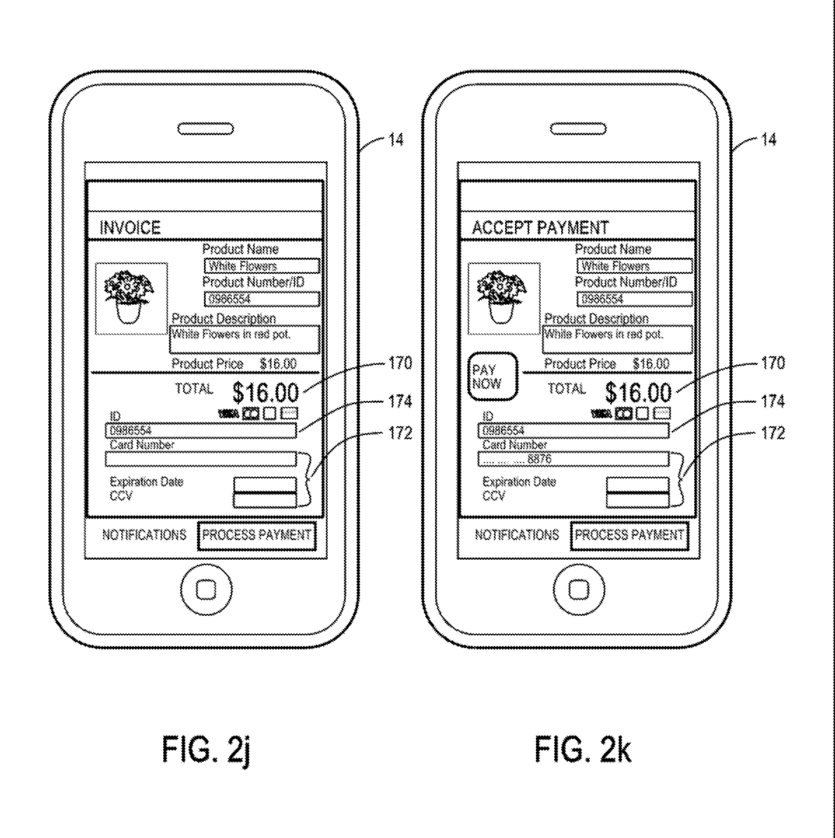

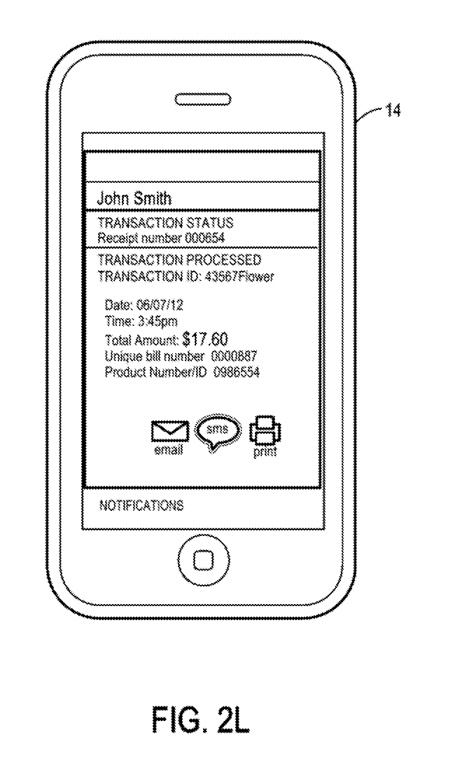

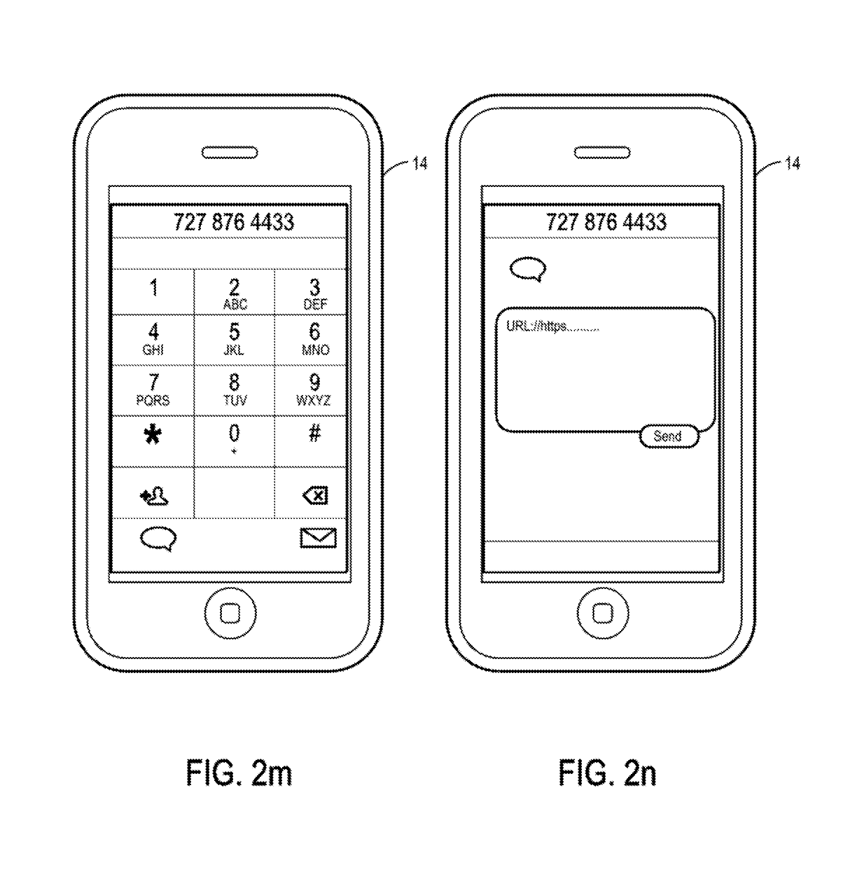

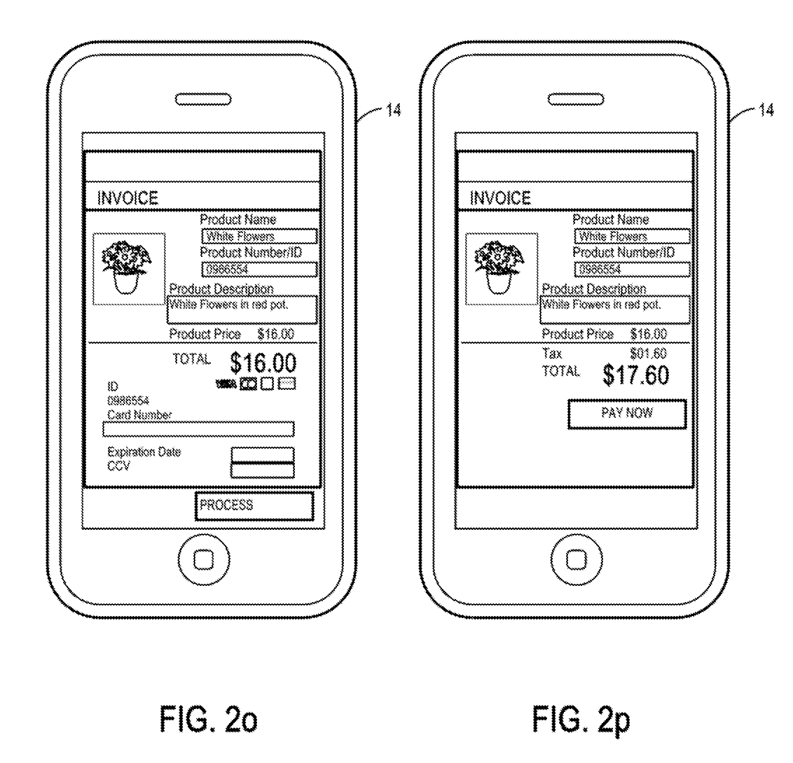

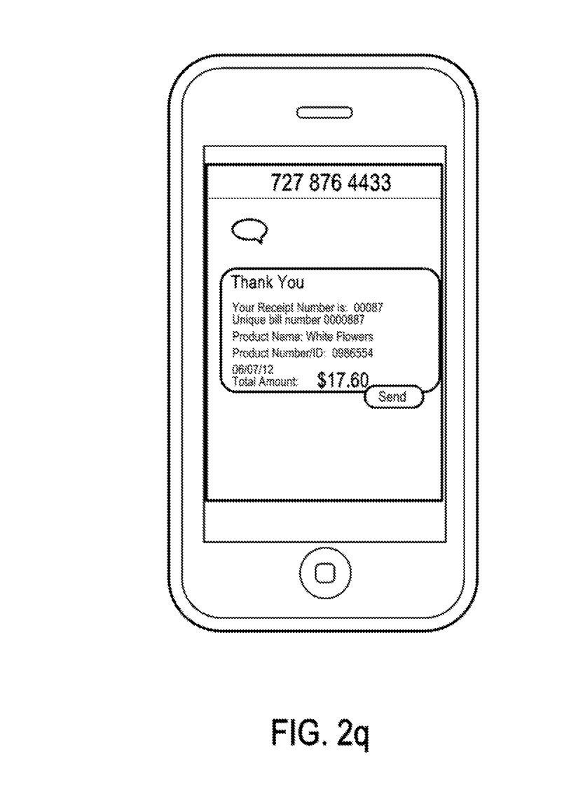

FIG. 2a shows the smart phone 14 of the merchant when it is used to start the application of the present invention. The merchant 12 is required to login to the mobile transaction processing application in order to use its features. The merchant 12 uses the mobile transaction processing application login credentials to login. The screen of the smart phone 14 includes relevant field for signing in to the application (the login), including a place to enter the company name at box 102, the user name at box 104 and the password at box 106, then a login box 108 which is activated when the information has been entered. While the user may manually enter his password at box 106, he may use the magnetic stripe reader 15 of FIG. 1a to enter the password for him, using the 16 digit (or 32 digits) of a selected credit card account number which he has previously identified as his password. In this way the user does not have to remember a long password or reduce the security by using a short password (if the application even allows him to use a short and unsecure password). Thus, a user may have several credit cards and when prompted for a password at the initial sign-up, he selects one of the credit cards (his VISA card, for example) and swipes it so that his VISA account number becomes his “password” for use in the mobile transaction processing application (and he does not have to remember the digits of the account number nor even key them in, his swipe of the card enters the digits automatically using the magnetic stripe reader 15 coupled to the terminal 14.

Once the login information is entered in FIG. 2a, the mobile transaction processing application 14d validates the merchant's credentials and, if validated successfully, generates a screen (FIG. 2b) with the application components displayed to the merchant 12. This screen includes a first icon 110 for the payment process, a second icon 112 for processor settings, a third icon 114 for search (for goods and services offered at the store), a fourth icon 116 for a file of past transactions, a fifth icon 118 for dealer settings and a sixth icon 120 for “pay now”.

A “keep alive” feature of the present mobile transaction processing application allows the part of the application resident on the merchant's terminal 14 to stay open as long as the merchant wants (if it is not subject to PCI regulations regarding security).

FIG. 2c illustrates applications which the merchant has on his smart phone or terminal 14 including those applications other than the mobile transaction processing of the present invention. So, in this case, there are icons for messages 133, calendar 134, YouTube 135, weather 136, mail 137 and phone 138, in addition to the StrongBox icon 132, which may be used to practice the mobile transaction processing of the present invention.

FIG. 2d illustrates the login using an e-wallet login card on the terminal 14. The card holder's name is entered at 140, the card number at 142 and the expiration date at 144, then presses the “save your logon card” button 146. Swiping the e-wallet login card through the magnetic stripe reader 15 provides the merchant 12 with an alternate method to manually entering a complex password to unlock the processing part of the mobile transaction processing application 14d of the present invention. This swiping of the credit card is used to validate the merchant's credentials, thus enabling him to quickly and securely unlock the hosted payment page. By keeping his smart phone or terminal 14 separate from his e-wallet login card when he is not using the mobile application, his smart phone 14 could not be used to process transactions. If the terminal 14 is stolen, unless the thief has the merchant's password or the e-wallet login card, the thief cannot process transactions using the terminal 14. This is similar to employees who share a single register in a store or restaurant and swipe their employee card to unlock the terminal and identify which clerk is making the transaction.

This application has the capability of using an integrated camera 150 which is carried on the smart phone 14 as shown in FIG. 2e. In FIG. 2f, the picture of a product 152 (a potted plant) is shown on the face of the smart phone 14 after the camera 150 has been used to capture the image of the product (and the application allows the merchant to include product information, both descriptive material and pricing information (as well as inventory information such as the number of product units on hand). In FIG. 2g, a customer has added additional items to a bill with corresponding pictures and description including quantity and price. In FIG. 2h, the price information is put into a bill with tax and miscellaneous charges (like shipping) added. The merchant can program the tax rate as desired and determine whether to add tax or not (for example, if the transaction is tax exempt, the merchant would not want the application to add tax). Similarly, the merchant can determine whether to add miscellaneous charges to a transaction depending on whether those charges apply to the transaction. The merchant can determine whether tax and miscellaneous charges are the default (subject to override) or if the merchant will manually select whether to add them to a given transaction, preferably selecting the most frequent situation as the default to require less thought and less override actions. The miscellaneous charge field is one where the merchant can define the charge and add a charge as appropriate (and the merchant may also have a miscellaneous credit option to allow him to provide for a discount, if applicable, for example, to a wholesale transaction, either based on the customer (customer x always gets a 10 percent discount), the size of the order (any order over $50 gets a discount) or based on another criteria (day of the week, time of day, closeout products, etc.) or a manual entry.

Once the order has been entered on the merchant's terminal 14 at FIG. 2i, then the customer has two options regarding payment: pay from merchant's terminal 14 or pay from customer's terminal 18.

FIG. 2j shows a display of the terminal or smart phone 14 displaying an invoice for paying from the merchant's terminal 14. Field 170 shows the amount due ($16.00 in this case) and fields 172 are for the customer to enter his credit card number, expiration date and CCV security code for payment processing by the payment system 26. Field 174 shows a transaction ID number for this transaction. FIG. 2k shows the merchant's terminal 14 after the payment has been accepted by the payment system 26, with an indication of the amount in field 170, some of the credit card information in field 172 (some of the information is blanked out for security reasons, as is conventional) and the transaction ID in field 174.

FIG. 2l is the screen on the merchant's terminal confirming that the payment has been processed, showing the amount of the transaction, the product(s) involved and a unique bill number. There are “buttons” below these entries to allow the merchant 12 to send a receipt to the customer and/or print a receipt at a local printer, as desired, and in this case the merchant 12 can select to send a confirming email or a SMS message. FIG. 2m shows the merchant's screen for entering an address for the customer 16, in this case a phone number. FIG. 2n provides a screen for sending a selected receipt to the customer once the customer's number has been entered.

FIG. 2o is a version of the communication where the payment is made at the customer's terminal 18 rather than at the merchant's terminal 14. The merchant sends the customer an invoice with the product(s) and the amount due listed on the invoice, along with a place to enter the customer's credit card information (or other payment information, such as a debit card or checking account information for an eCheck transfer). In FIG. 2p the customer has a screen which includes a “pay now” button to communicate his payment information to the payment processor 26 securely and without sharing the card information with the merchant 12. When the payment has been made, a receipt for the transaction is send to the customer, see FIG. 2q.

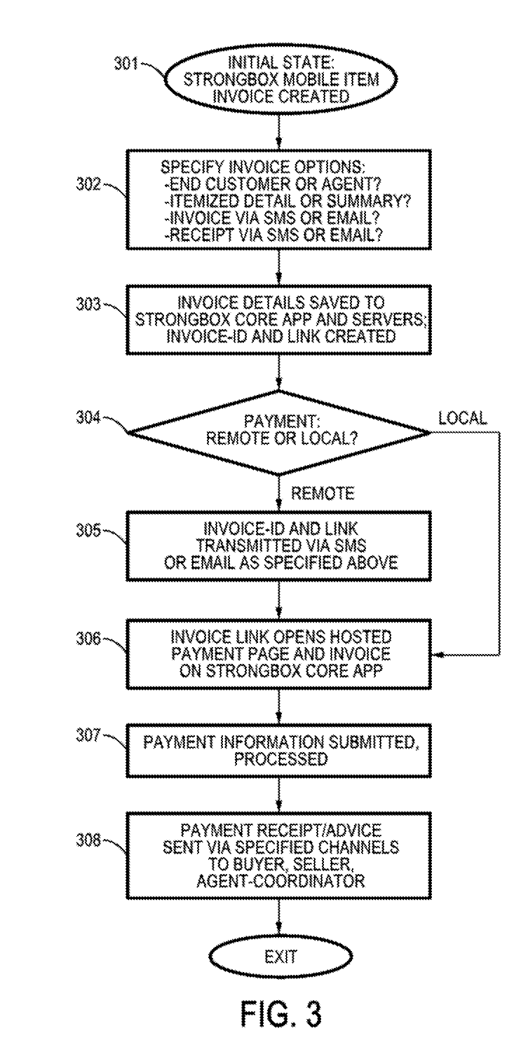

FIG. 3 illustrates a flow chart for the mobile payment processing application of the present invention for invoicing and payment processing of a retail transaction entered on a mobile terminal 14 of the merchant 12 and relating to a customer 16.

The application has an initial state at block 301 after the mobile application has been launched, the merchant authenticated, an item invoice created including the name of the seller (the merchant 12) the buyer (customer 16), an itemized listing, taxes, shipping and total amount due.

Next, at block 302, the invoice options are specified, with details such as end customer or agent?, itemized invoice detail or summary?, how to invoice (e.g., by SMS or by email)? And how (and whether) to provide a receipt (e.g., SMS or email)? At block 303 the invoice detail is saved at the application 14d (and, optionally, its remote servers), and an invoice id and link is created. At block 304 the type of payment is specified, whether it is local or remote. A local payment is accomplished at the point of sale and may be a credit card transaction or a cash payment. If the payment option selected at block 304 is remote, then at block 305 the invoice id and link are transmitted via SMS or email to the customer's terminal 18 using the network 22 and the links 20, 24 shown and described in connection with FIG. 1. The customer in the case of remote payment accomplishes a transaction which is communicated back to the merchant's terminal in the form of a “payment” (a payment via credit card or a payment from a third party.) Then at block 306, regardless of the form of payment, the invoice link opens hosted payment page and invoice on the mobile transaction application. At block 307 the payment information is submitted and processed and at block 308, payment receipt/advice sent via the specified channels to buyer, seller and any agent or coordinator.

The preferred embodiments of the present invention have been described with some specificity for the sake of illustration, although the invention is not limited to the exact configuration or methods disclosed, as one of ordinary skill in the art will understand the invention from the teachings herein and recognize that many alterations and deviations are possible without departing from the spirit of the invention. Accordingly, it will be understood that the description of the preferred embodiments has been provided to illustrate one embodiment of the present invention, and not to limit the scope of the invention. A man of ordinary skill in the art will also recognize that some of the features of the present invention can be used to advantage without the corresponding use of other features. For example, the use of the magnetic stripe input could be avoided in some embodiments and the communication of a transaction to a customer's smart phone would be unnecessary if the customer did not object to providing his payment information directly to the merchant. Further, the use of the smart phone as a store front and including inventory information, although useful, is not required in the practicing of the present invention, nor are the additional features such as inventory management and replenishment.

Finally, some of the devices, functions and/or processes are shown separately, not because they must be separate, but for ease in understanding the components ((devices, functions and/or processes) and could be combined into a single device, if desired, or arranged in a different configuration as desired. The teaching of the preferred embodiment of the present invention uses the functions of a separate magnetic stripe reader, for example, as discussed herein, but a similar function can easily be obtained by integrating an input device such as a magnetic stripe reader with the communication device, if desired, and other suitable devices could be used in place of the magnetic stripe reader, if desired—for example, a bar code reader, OCR or even MICR reading. Accordingly, the present invention is not limited to the specific embodiment of a separate magnetic stripe reader as discussed in connection with the preferred embodiment. It should also be appreciated that a reader could be integrated with the merchant's terminal or smart phone, if desired, particularly if some versions of smart phones include a reader (for example, a bar code reader) as a part of the smart phone. The disclosure of a magnetic stripe for an identity verification in the present example could also be altered, if desired, and the identity verification could be performed in an other manner, such as a biometric identification or through some form of PIN or password verification, if desired, either alone or in combination with a magnetic stripe verification (so the magnetic stripe might be supplemented by a PIN, if desired). The magnetic stripe might be used for the identification of the user (the username is the account number on the card, for example, or material in one of the other lines of the magnetic stripe), with a suitable identity verification (such as a biometric identifier) as well, if desired. Further, in some cases, the customer or merchant might have access to a separate magnetic stripe reader so that it is not necessary to use the magnetic stripe reader attached to the merchant's smart phone for all magnetic stripe reading in the present invention, but that might require an application to be resident (downloaded from server through the Internet and over a wireless data transmission link) to support such a stripe reader or the customer's terminal. Accordingly, it will be appreciated that the foregoing description of the preferred embodiment is for the purpose of describing aspects of the present invention and not in limitation thereof, the scope of the invention being defined in the claims which follow.

Having thus described the invention, what is claimed is:

1. A method of processing a retail transaction using a mobile device, the steps of the method comprising:
Coupling a magnetic stripe reader to a portable terminal, the terminal including software for capturing data related to the transaction;
Using a magnetic stripe reader to read a magnetic stripe on a user's card to identify the user; and
Verifying the user at the terminal using the read magnetic stripe before processing a transaction.

2. The method including the steps of claim 1 further including the step of using the magnetic stripe reader to capture account information from a customer.

3. The method of claim 1 further including the step of entering contact information for the customer of a transaction and sending the customer a report of the transaction using the contact information for the customer.

4. The method of claim 3 further including the step of receiving a return message relating to the transaction initiated by the customer.

5. The method of claim 4 wherein the return message initiated by the customer includes payment information.

6. The method of claim 5 wherein the method further includes the step of the customer entering his payment information and sending it to a payment processing system.

7. A system for processing a retail transaction comprising:
A smart phone for receiving a transaction input and communicating with a transaction processing system;
A magnetic strip scanner coupled to the smart phone for reading indicia from a magnetic stripe and communicating that information to the transaction processing system; and
The smart phone including a stored program for generating information on a transaction and for receiving information from the transaction processing system approving the transaction.

8. The system of claim 7 further comprising:

9. A program fixed on a fixed medium comprising:
A first module for conducting a retail transaction at a mobile device;
A second module for identifying a user, said module receiving an input from a magnetic stripe for identifying the user from a read magnetic stripe;
A third module for receiving customer information from the same magnetic stripe reader; and
A fourth module for recording a payment for the transaction.

10. A program of the type described in claim 9 wherein the program further includes a module for coupling to a data transmission network for recording details on the transaction at a remote site.

11. A program of the type described in claim 9 further including a module for receiving payment information from a data transmission network.
